(19) United States
(12) Patent Application Publication
(10) Pub. No.: US 2026/0126293 A1
(43) Pub. Date: May 7, 2026

(54) MOVING ROUTE RECOMMENDING METHOD IN VIRTUAL FIELD

(71) Applicant: Cheng Feng Tai, Kaohsiung City (TW)

(72) Inventor: Cheng Feng Tai, Kaohsiung City (TW)

(21) Appl. No.: 19/365,362

(22) Filed: Oct. 22, 2025

(30) Foreign Application Priority Data
Nov. 1, 2024 (TW) 113142003

(51) Int. Cl. G01C 21/20; G06T 11/00

(52) U.S. Cl. CPC G01C 21/206; G06T 11/00

(57) ABSTRACT

A moving route recommending method in a virtual field is performed by a processor and comprises: receiving a real-field map and multiple virtual-field maps; setting a beginning point and a terminal point in each virtual-field map within a real movable range of the real-field map; arranging a position of each virtual-field map to have a maximum overlapping area between a virtual map range of the virtual-field map and the real movable range; generating multiple routes different from each other according to a node number, the beginning point, and the terminal point in each virtual-field map; setting the first N routes with lengths longer than the rest routes within the real movable range as recommending routes of the virtual-field maps; and controlling a monitor to display the recommending routes.

### CROSS REFERENCE TO RELATED APPLICATIONS

The present application claims priority to Taiwan application No. 113142003, filed on Nov. 1, 2024, the content of which is hereby incorporated by reference in its entirety.

### BACKGROUND OF THE INVENTION

### 1. Field of the Invention

The present application relates generally to a moving route recommending method, and more particularly to a moving route recommending method in a virtual field.

### 2. Description of Related Art

In the activity of Room-Scale Virtual Reality (VR), a participator would wear a VR headset and go into a designed indoor space. The participator can watch the scenes of a virtual field displayed by the VR headset and accordingly walk around in the indoor space. However, there are real, physical walls surrounding the indoor space. So, the moving routes for the participator in the virtual field should be planned to correspond to the indoor space for preventing the participator from colliding with the wall. For example, when the participator is approaching the wall, the VR headset may display an impassible scene (such as a marking line, a sign, a cliff, a river, a mountain, etc.) for the participator to see and notice the impassible scene. By doing so, the impassible scene will stop the participator from walking forward.

However, the route planning for the virtual field can only be done after long discussions by the director and the production team (including computer graphic designers or engineers, computer programmers, etc.). As a result, the preparation costs for a Room-Scale VR product is hardly reduced. Besides, when the moving routes in the virtual field are planned improperly, the indoor space may not be utilized efficiently. So, the participator will finish the walk in the virtual field very soon and has poor experience.

### SUMMARY OF THE INVENTION

An objective of the present invention is to provide a moving route recommending method in a virtual field to overcome the defects as mentioned in the related art, such as hardly reduceable preparation costs of the VR product and low utilization efficiency of the indoor space due to improper planning of the moving routes in the virtual field.

The moving route recommending method in the virtual field is performed by a processor and comprises:
receiving a real-field map and multiple virtual-field maps; wherein the real-field map has information of a real movable range, each virtual-field map has information of a virtual map range, and the multiple virtual-field maps include a first virtual-field map and a second virtual-field map;
setting a first beginning point and a first terminal point to the first virtual-field map within the real movable range;
arranging a position of the first virtual-field map to have a maximum overlapping area between the virtual map range of the first virtual-field map and the real movable range;
setting a second beginning point and a second terminal point to the second virtual-field map within the real movable range, wherein a position of the second beginning point corresponds to a position of the first terminal point of the first virtual-field map;
arranging a position of the second virtual-field map to have a maximum overlapping area between the virtual map range of the second virtual-field map and the real movable range;
generating multiple first routes different from each other according to a first-node number, the first beginning point, and the first terminal point in the first virtual-field map, and setting the first N first routes with lengths longer than the rest first routes within the real movable range as N recommending routes of the first virtual-field map; wherein N is a preset number as a positive integer larger than 1, and each first route passes through the first-node number of first nodes;
generating multiple second routes different from each other according to a second-node number, the second beginning point, and the second terminal point in the second virtual-field map, and setting the first M second routes with lengths longer than the rest second routes within the real movable range as M recommending routes of the second virtual-field map; wherein M is a preset number as a positive integer larger than 1, and each second route passes through the second-node number of second nodes; and
controlling a monitor to display the N recommending routes of the first virtual-field map and the M recommending routes of the second virtual-field map.

The present invention has the following technical effects.

1. The moving route recommending method in the virtual field of the present invention is performed by the processor to automatically generate and display the recommending routes suitable for the real indoor space as references for the director and the production team. The discussions by the director and the production team for the planning of the routes in the virtual field would be greatly reduced. So, the preparation costs could be reduced efficiently. Please note that the real-field map in the present invention is not limited to correspond to the indoor space. Alternatively, the real-field map may correspond to an outdoor space. The indoor space application of the real-field map is just an example in the present invention.

2. In the present invention, the position of each virtual-field map is arranged to have a maximum overlapping area between the virtual map range of such virtual-field map and the real movable range. Hence, based on the foregoing maximum overlapping area, the recommending routes are the longest ones or longer than the rest, such that the indoor space can be utilized efficiently. Besides, the recommending routes are displayed for the director's and the production team's review. The director and the production team can refer to the recommending routes to do their works, such as plots drafting, art projects, and so on. By doing so, the VR product will provide the participator with the maximized or optimized moving routes in the virtual field, so as to efficiently improve the participator's immersive experience.

3. The real-field map corresponds to the real interior configuration of the indoor space. The processor of the present invention can set a gap between the boundary of the real movable range of the real-field map and the walls of the indoor space. The real movable range of the real-field map is the maximum range where the participator can move. So, the present invention can ensure that the participator will not collide with the real wall of the indoor space during the walk of the participator's immersive experience.

### BRIEF DESCRIPTION OF THE DRAWINGS

FIGS. 1A and 1B are a flow charts of an embodiment of the moving route recommending method in a virtual field of the present invention.

FIG. 2 is a schematic diagram of an embodiment of a real-field map of the present invention.

FIG. 3A is a schematic diagram of an embodiment of a first virtual-field map of the present invention.

FIG. 3B is a schematic diagram of an embodiment of a second virtual-field map of the present invention.

FIG. 3C is a schematic diagram of an embodiment of a third virtual-field map of the present invention.

FIG. 3D is a schematic diagram of an embodiment of a fourth virtual-field map of the present invention.

FIG. 4 is a schematic diagram of an embodiment that sets a beginning point and a terminal point to the first virtual-field map within the real movable range of the real-field map of the present invention.

FIG. 5 is a schematic diagram of an embodiment that arranges the position of the first virtual-field map of the present invention.

FIG. 6 is a schematic diagram of an embodiment that sets a beginning point and a terminal point to the second virtual-field map within the real movable range of the real-field map of the present invention.

FIG. 7 is a schematic diagram of an embodiment that arranges the position of the second virtual-field map of the present invention.

FIG. 8 is a schematic diagram of an embodiment of a finished arrangement including the first to the fourth virtual-field maps of the present invention.

FIG. 9 is a schematic diagram of an embodiment that generates multiple different first routes in the first virtual-field map of the present invention.

FIG. 10 is a first schematic diagram of an embodiment that sets the first routes longer than others as the recommending routes within the real movable range of the real-field map of the present invention.

FIG. 11 is a schematic diagram depicting the generation of the first routes of an embodiment of the present invention.

FIG. 12 is a schematic diagram of an embodiment that respectively generates the recommending routes in the first to the fourth virtual-field maps of the present invention.

FIG. 13 is a schematic diagram depicting virtual movable ranges within the first to the fourth virtual-field maps respectively of an embodiment of the present invention.

FIG. 14 is a second schematic diagram of an embodiment that sets some of the first routes longer than others as the recommending routes within the real movable range of the real-field map of the present invention.

FIG. 15 is a schematic diagram of an embodiment that sets an additional beginning point within the first virtual-field map of the present invention.

FIG. 16 is a schematic diagram of an embodiment that sets additional beginning points within the first to the fourth virtual-field maps respectively of the present invention.

FIG. 17 is a schematic diagram of an embodiment that generates the additional recommending routes in the first virtual-field map of the present invention.

FIG. 18 is a block diagram of a system for recommending moving routes in the virtual field of the present invention.

### DETAILED DESCRIPTION OF PREFERRED EMBODIMENT(S)

The moving route recommending method in the virtual field of the present invention is performed by a processor. For example, the processor may be a central processing unit (CPU). The method of the present invention may be implemented in an operating environment by a software development kit, such as Unity and Unreal.

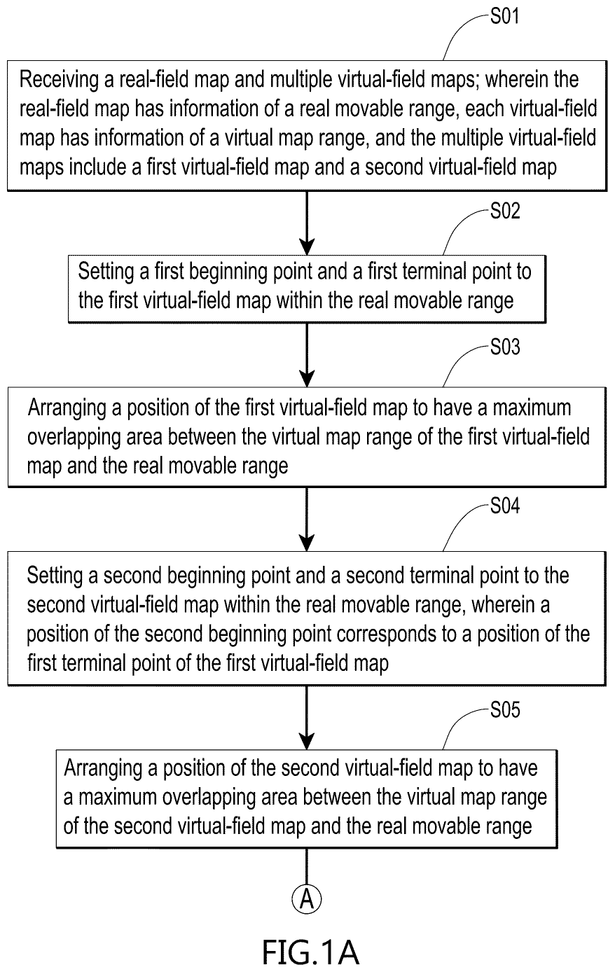

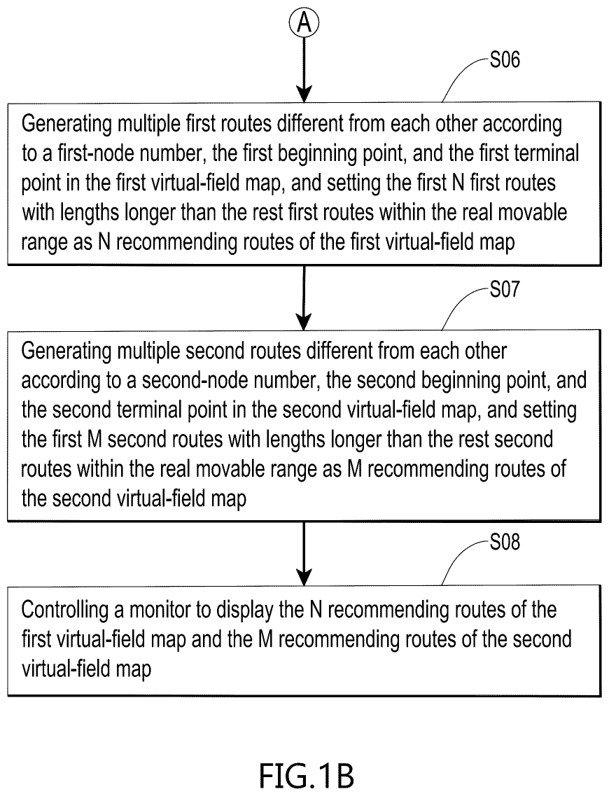

With reference to FIGS. 1A and 1B, an embodiment of the moving route recommending method in the virtual field of the present invention comprises the following steps.

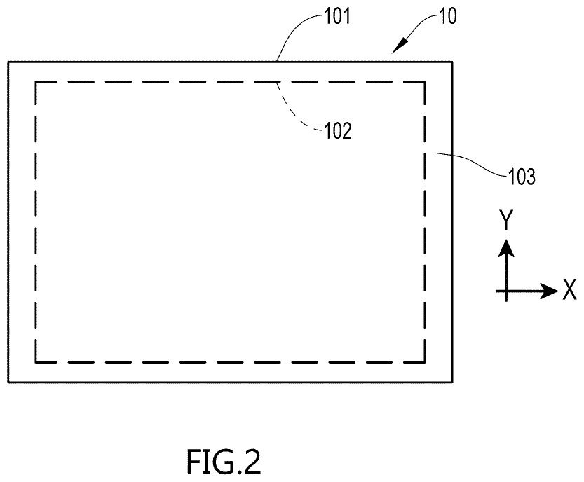

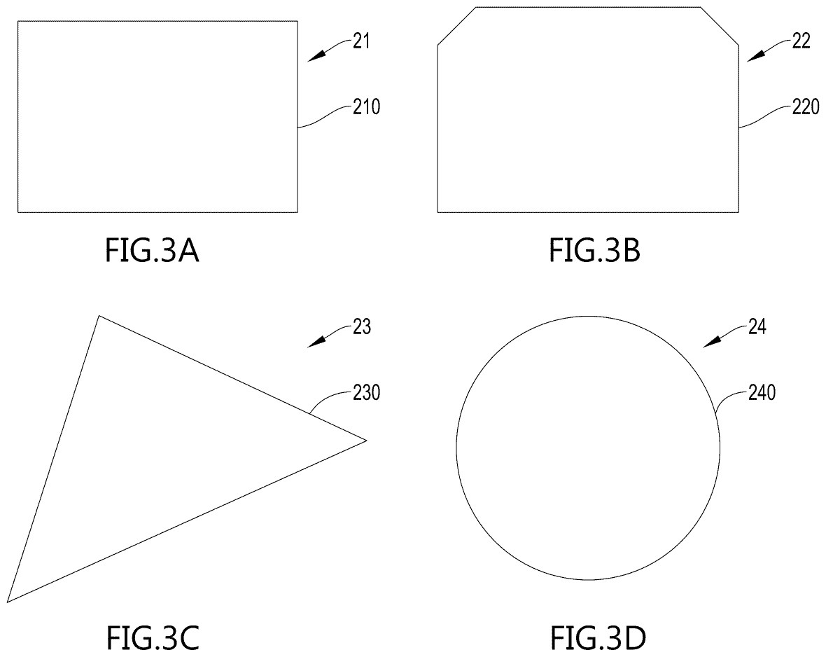

Step S01: The processor receives to obtain a real-field map and multiple virtual-field maps; wherein the real-field map has information of a real movable range, each virtual-field map has information of a virtual map range, and the multiple virtual-field maps include a first virtual-field map and a second virtual-field map. In an embodiment, electronic files of the real-field map and the virtual-field maps may be stored in a storage known as a computer readable/writable medium. For example, the storage may be a hard disk drive (HDD) or a solid-state drive (SSD). The processor communicates with the storage, such that the processor can receive and obtain the real-field map and the virtual-field maps. The real-field map and the virtual-field maps are established in the same coordinate system. The real-field map is applicable to an indoor space for Extended Reality (XR), Augmented Reality (AR), Virtual Reality (VR), and Mixed Reality (MR). Participators can walk around in the indoor space. So, the real-field map corresponds to the walkable and movable areas for the participators. Besides, the real-field map is not limited to be applicable for the indoor space. Alternatively, the real-field map can be applicable for an outdoor space, either. In the present invention, the indoor application is the example to be described. The real-field map is the electronic map data corresponding to the indoor space. With reference to FIG. 2 and an example, the X axis and the Y axis make a horizontal plane as a ground of the indoor space. The real-field map 10 has information of a real map range 101 and a real movable range 102. The positions of the real map range 101 and the real movable range 102 are defined by coordinates. The boundary of the real map range 101 may correspond to the walls or other obstacles in the indoor space. The real movable range 102 is located within the real map range 101. The boundary of the real movable range 102 is apart from the boundary of the real map range 101 by a gap 103. The shape of the real map range 101 and the real movable range 102 is not limited to rectangle as shown in FIG. 2. Each virtual-field map is the electronic map data of a virtual space. For example, the virtual space may comprise game scenes. Each virtual-field map has a virtual map range. The position of the virtual map range is defined by space coordinates. The shape of the virtual map range may be any shape. The participator will have a broader viewing experience from the virtual map range than from the indoor space. For convenience of describing the present invention and simplifying the description, the foregoing multiple virtual-field maps may comprise a first virtual-field map 21 shown in FIG. 3A and a second virtual-field map 22 shown in FIG. 3B. The shape of the virtual map range 210 of the first virtual-field map 21 is rectangular as an example. The shape of the virtual map range 220 of the second virtual-field map 22 is hexagonal as an example. In addition, FIG. 3C and FIG. 3D respectively depict a third virtual-field map 23 and a fourth virtual-field map 24 included in the foregoing multiple virtual-field maps. The shape of the virtual map range 230 of the third virtual-field map 23 is triangular as an example. The shape of the virtual map range 240 of the fourth virtual-field map 24 is circular as an example.

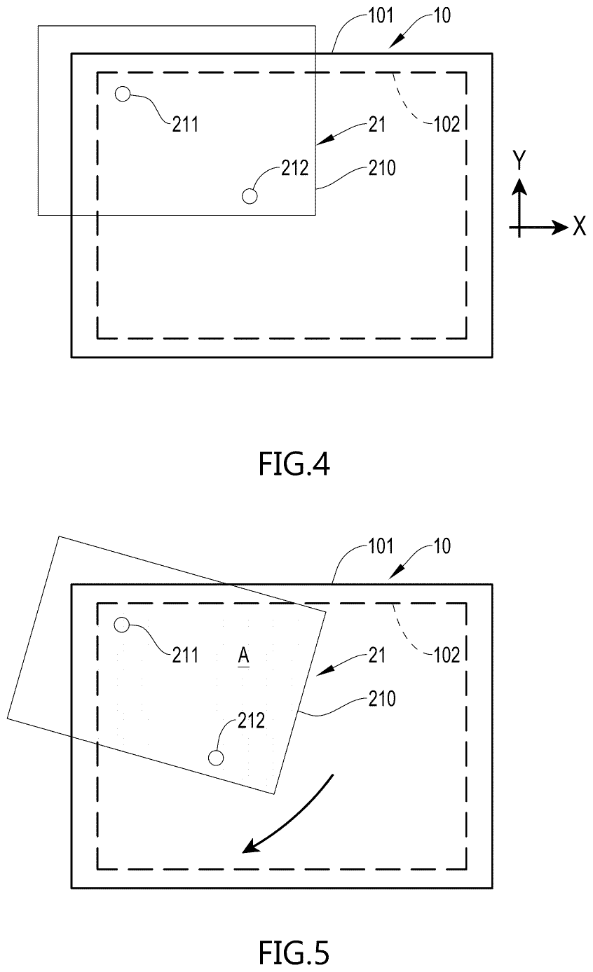

Step S02: The processor sets a first beginning point and a first terminal point to the first virtual-field map within the real movable range. In an embodiment, the processor may communicate with an input device, such as a keyboard or a mouse of a computer. So, with reference to FIG. 4, according to control commands from the input device operated by the user, the processor sets a beginning point (hereinafter “first beginning point 211”) and a terminal point (hereinafter “first terminal point 212”) to the first virtual-field map 21. The first beginning point 211 and the first terminal point 212 are located within the real movable range 102. The positions of the first beginning point 211 and the first terminal point 212 are defined by coordinates. For example, the first beginning point 211 stands for the entrance for entering the first virtual-field map 21, and the first terminal point 212 stands for the exit for leaving the first virtual-field map 21.

Step S03: The processor arranges a position of the first virtual-field map to have a maximum overlapping area between the virtual map range of the first virtual-field map and the real movable range. In an embodiment, with reference to FIG. 5, the processor rotates the first virtual-field map 21 around the first beginning point 211 as a fixed point for a circulation (360 degrees). Please note that to rotate the map by the processor is common knowledge in the art, such as by matrix and/or vector computation. That is, the first virtual-field map 21 is rotated for one circulation relative to the real-field map 10. The rotating direction of the first virtual-field map 21 is not limited to clockwise or counter-clockwise. During the rotation of the first virtual-field map 21, the processor computes an overlapping area A between the virtual map range 210 of the first virtual-field map 21 and the real movable range 102. It is understandable that the overlapping area A is changing during the rotation, so the processor may record a series of the overlapping area A and perform a comparison to adjacent two of them. Please note that the computing principle of computer programs for computing and comparing the overlapping area A is common knowledge in the art. The processor of the present invention mainly disposes the first virtual-field map 21 at a position where the overlapping area A is maximum. Therefore, suppose FIG. 4 is the determination result by the processor. Under the condition that both the first beginning point 211 and the first terminal point 212 are located within the real movable range 102, the virtual map range 210 of the first virtual-field map 21 and the real movable range 102 have the maximum overlapping area.

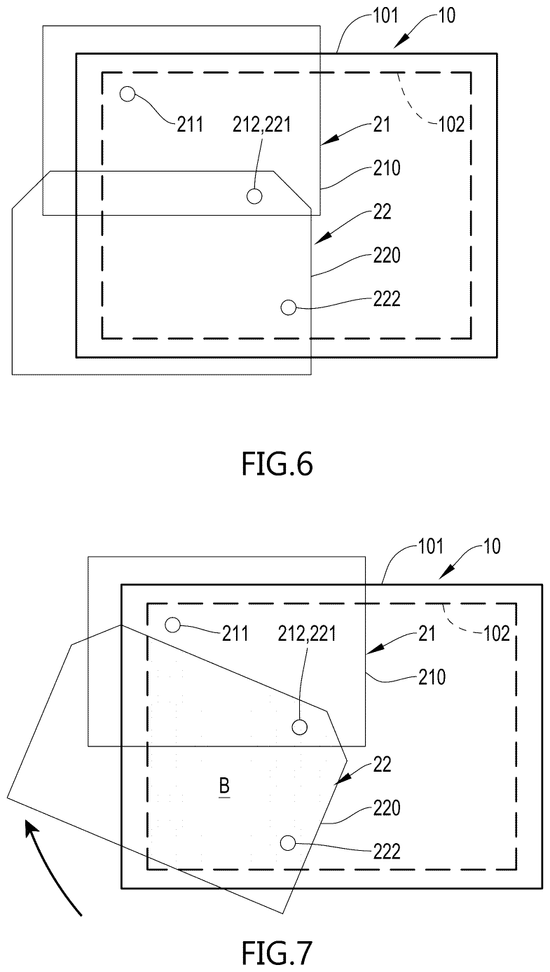

Step S04: The processor sets a second beginning point and a second terminal point to the second virtual-field map within the real movable range, wherein a position of the second beginning point corresponds to a position of the first terminal point of the first virtual-field map. This step S04 can be deduced from step S02. In brief, with reference to FIG. 6, according to control commands from the input device operated by the user, the processor sets a beginning point (hereinafter “second beginning point 221”) and a terminal point (hereinafter “second terminal point 222”) to the second virtual-field map 22. The second beginning point 221 and the second terminal point 222 are located within the real movable range 102. The positions of the second beginning point 221 and the second terminal point 222 are defined by coordinates. In an embodiment, the position of the second beginning point 221 may correspondingly overlap the position of the first terminal point 212 of the first virtual-field map 21, which means the entering into the second virtual-field map 22 via the second beginning point 221 after the leaving from the first virtual-field map 21 via the first terminal point 212.

Step S05: The processor arranges a position of the second virtual-field map to have a maximum overlapping area between the virtual map range of the second virtual-field map and the real movable range. This step S05 can be deduced from step S03. In brief, with reference to FIG. 7, the processor rotates the second virtual-field map 22 around the second beginning point 221 as a fixed point for a circulation (360 degrees). That is, the second virtual-field map 22 is rotated for one circulation relative to the real-field map 10. During the rotation of the second virtual-field map 22, the processor computes an overlapping area B between the virtual map range 220 of the second virtual-field map 22 and the real movable range 102. Suppose FIG. 6 is the determination result by the processor. Under the condition that both the second beginning point 221 and the second terminal point 222 are located within the real movable range 102, the virtual map range 220 of the second virtual-field map 22 and the real movable range 102 have the maximum overlapping area.

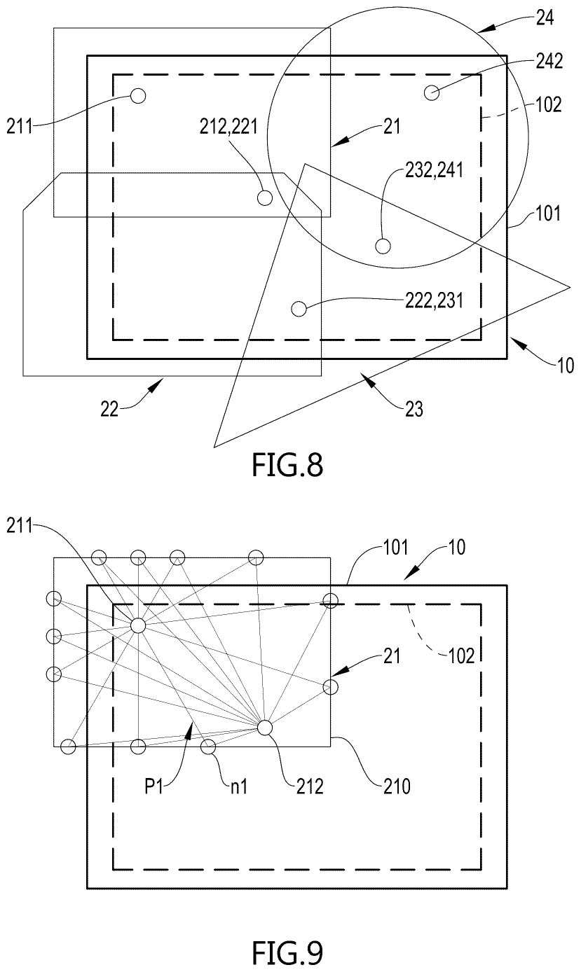

It can be deduced that in an embodiment, FIG. 8 depicts the finished arrangement of the first to the fourth virtual-field maps 21-24 accomplished by the processor. Each one of the first to the fourth virtual-field maps 21-24 and the real movable range 102 have the respective maximum overlapping area. In an embodiment, the third virtual-field map 23 has a third beginning point 231 and a third terminal point 232; and the fourth virtual-field map 24 has a fourth beginning point 241 and a fourth terminal point 242. The position of the third beginning point 231 may correspondingly overlap the position of the second terminal point 222 of the second virtual-field map 22. The position of the fourth beginning point 241 may correspondingly overlap the position of the third terminal point 232 of the third virtual-field map 23.

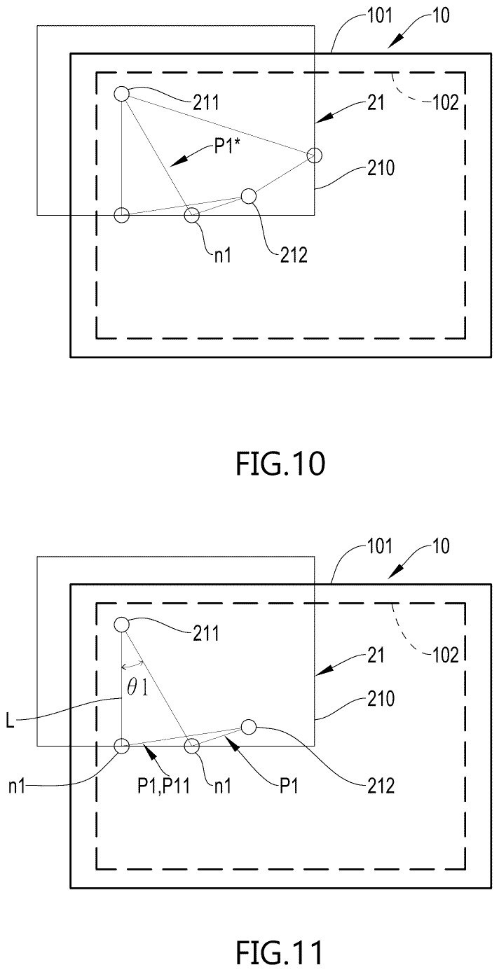

Step S06: The processor generates multiple first routes different from each other according to a first-node number, the first beginning point, and the first terminal point in the first virtual-field map, and sets the first N first routes with lengths longer than the rest first routes within the real movable range as N recommending routes of the first virtual-field map; wherein N is a preset number as a positive integer larger than 1, and each first route passes through the first-node number of first nodes. In an embodiment, the first-node number is one of preset parameters for the processor to generate the multiple first routes. The first-node number is the number of the first node(s) in each first route. For example, the first-node number may be 1, which means each first route has one first node. The position of the first node is defined by coordinates. So, in the step of generating the multiple first routes by the processor, with reference to FIG. 9 (please note that the second to the fourth virtual-field maps 22-24 of FIG. 8 are omitted from FIG. 9), the processor generates one first route P1 from the first beginning point 211 to the first terminal point 212 via one first node n1. The positions of the first nodes n1 in the first routes P1 are different from each other. In an embodiment, the processor may preset the positions of the first nodes n1 on the boundary of the virtual map range 210 of the first virtual-field map 21 for maximizing the route lengths. For each first route P1, the first node n1 is as a turning point. The processor determines whether each first route P1 is within the real movable range 102 in order to sort the first route(s) P1 within the real movable range 102. With reference to FIG. 9 and FIG. 10, the processor sets the first N first routes P1 whose lengths are longer than the rest first routes P1 within the real movable range 102 as the N recommending routes P1*. In an embodiment, the length of each first route P1 is the sum of a direct-line length from the first beginning point 211 to the first node n1 and a direct-line length from the first node n1 to the first terminal point 212. Regarding the recommending routes P1* within the real movable range 102, no coordinate of such recommending routes P1* overlaps with any coordinate of the boundary of the real movable range 102. In other words, when a first route P1 has any coordinate overlapping with any coordinate of the boundary of the real movable range 102, such first route P1 cannot be set as the recommending routes P1* because such first route P1 intersects with the boundary of the real movable range 102 and is not located within the real movable range 102. In an embodiment, with reference to FIG. 11, when the processor generates a first one first route P11, the processor may preset the first node n1 to any (random) position on the boundary of the virtual map range 210 of the first virtual-field map 21, and further define a line configured from the first beginning point 211 to the first node n1 as a base line L. The base line L is a part line of the first route P11. According to a first angle parameter θ1, and for two adjacent first routes P1 (including P11), the processor defines an angle between a straight line from the first beginning point 211 to the first node n1 of one of such two first routes P1 and another straight line from the first beginning point 211 to the first node n1 of the other first route P1. The number of the first routes P1 is determined by the first angle parameter θ1. For example, the number of the first routes P1 is X, such that X may be represented as X=360°÷θ1. With reference to FIG. 9 as an example, when θ1=360°, X is equal to 12. So, after the processor establishes the first one first route P11, the processor will generate other X-1 first routes P1 according to a first angle parameter θ1.

Step S07: The processor generates multiple second routes different from each other according to a second-node number, the second beginning point, and the second terminal point in the second virtual-field map, and sets the first M second routes with lengths longer than the rest second routes within the real movable range as M recommending routes of the second virtual-field map; wherein M is a preset number as a positive integer larger than 1, and each second route passes through the second-node number of second nodes. This step S07 can be deduced from step S06. For example, the second-node number may be 1. According to a second angle parameter, and for two adjacent second routes, the processor defines an angle between a straight line from the second beginning point to the second node of one of such two second routes and another straight line from the second beginning point to the second node of the other second route. In an embodiment, the second angle parameter and the first angle parameter may be the same to or different from each other.

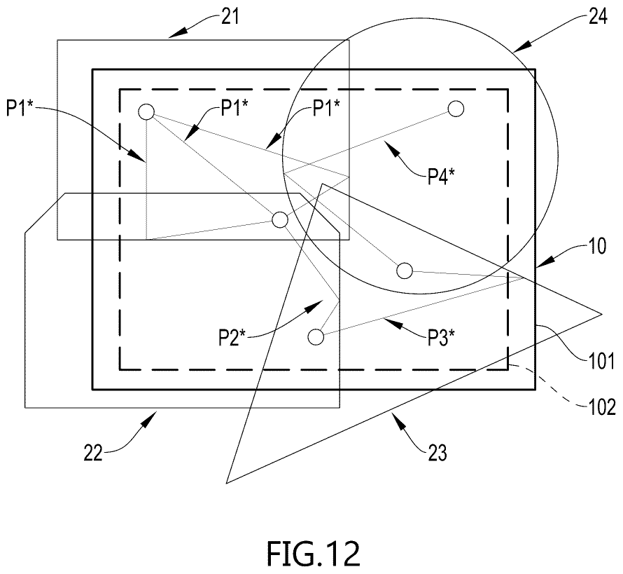

It can be deduced that in an embodiment, with reference to FIG. 12, the processor will generate one or multiple recommending routes P1*, P2*, P3*, P4* for the first to the fourth virtual-field maps 21-24 respectively.

Step S08: The processor controls a monitor to display the N recommending routes of the first virtual-field map and the M recommending routes of the second virtual-field map. In an embodiment, the processor communicates with the monitor. The monitor may be a liquid crystal display (LCD) as an example. In this step S08, the recommending routes P1*, P2*, P3*, P4* of the first to the fourth virtual-field maps 21-24 are visualized to be displayed on the monitor. So, a person such as a director may view the content as shown in FIG. 12. Hence, the director and the production team may select suitable routes from the recommending routes P1*, P2*, P3*, P4* to use based on the needs of plots. The feature of the recommending routes P1*, P2*, P3*, P4* is to provide the participators of Extended Reality (XR), Augmented Reality (AR), Virtual Reality (VR), and Mixed Reality (MR) longer walkable or movable distances (based on the foregoing step of computing the maximum overlapping area). Besides, the participator's movable range will not exceed the real movable range 102 to ensure that there is a safety gap between the participator and the real wall to prevent the participator from colliding with the real wall.

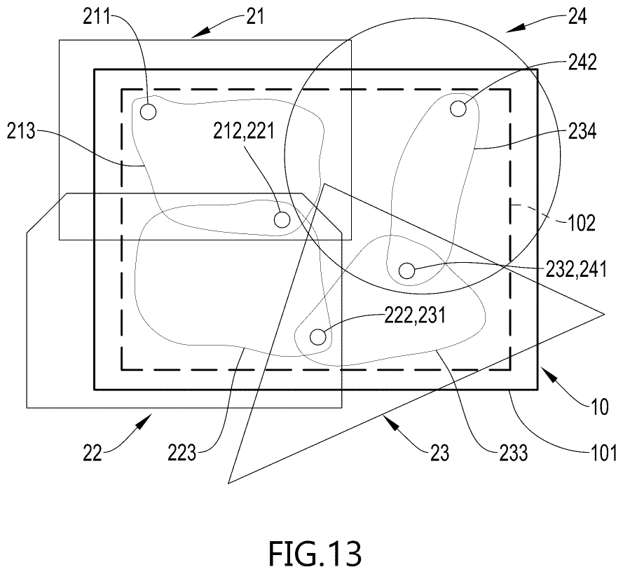

In an embodiment, the virtual map range of each virtual-field map has a virtual movable range. The position of the virtual movable range is defined by coordinates. That is, the participators experimenting Extended Reality (XR), Augmented Reality (AR), Virtual Reality (VR), and Mixed Reality (MR) can just move within the virtual movable range. For example, impassible scene (such as a marking line, a sign, a cliff, a river, a mountain wall, etc.) can be shown on the boundary of the virtual movable range of the virtual-field map. With reference to FIG. 13, in the step of arranging the position of the first virtual-field map 21 by the processor, under the condition that the virtual movable range 213 of the first virtual-field map 21 is located within the real movable range 102, the virtual map range 210 of the first virtual-field map 21 and the real movable range 102 have the maximum overlapping area. For the same reason, in the step of arranging the position of the second virtual-field map 22 by the processor, under the condition that the virtual movable range 223 of the second virtual-field map 22 is located within the real movable range 102, the virtual map range 220 of the second virtual-field map 22 and the real movable range 102 have the maximum overlapping area. Similarly, the third virtual-field map 23 and the fourth virtual-field map 24 may also have the virtual movable ranges 233, 243 respectively, and the arrangement for the virtual movable ranges 233, 243 can be deduced correspondingly.

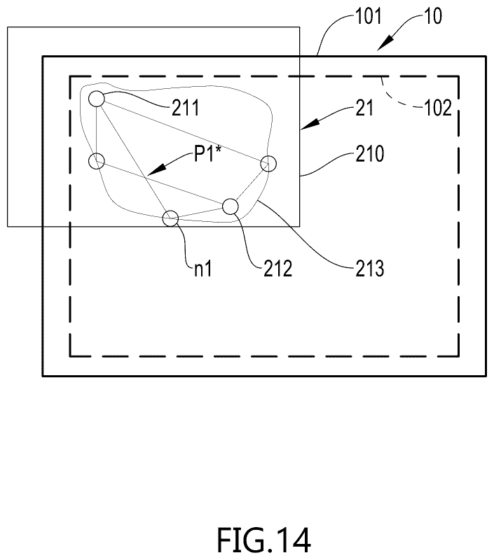

In the foregoing embodiments, as shown in FIG. 9 to FIG. 11, the processor presets a position of the first node n1 on the boundary of the virtual movable range 210 of the first virtual-field map 21, and the node arrangements for the rest virtual-field maps can be deduced correspondingly. In the embodiment with the virtual movable ranges 213,223,233,243 as shown in FIG. 13, the recommending routes P1*, P2*, P3*, P4* may be disposed in the virtual movable ranges 213,223,233,243. That is, the processor presets the positions of the nodes on the boundaries of the virtual movable ranges 213,223,233,243 of the first to the fourth virtual-field maps 21-24 respectively, and arranges each recommending route to pass through the corresponding node based on the foregoing approach of generating the recommending routes P1*, P2*, P3*, P4*, such that the recommending routes P1*, P2*, P3*, P4* can be disposed in the virtual movable range 213,223,233,243 by the processor. With reference to FIG. 14 as an example, the processor may preset the position of the first node n1 on the boundary of the virtual movable range 213 of the first virtual-field map 21, and the node arrangements for the rest virtual-field maps can be deduced correspondingly.

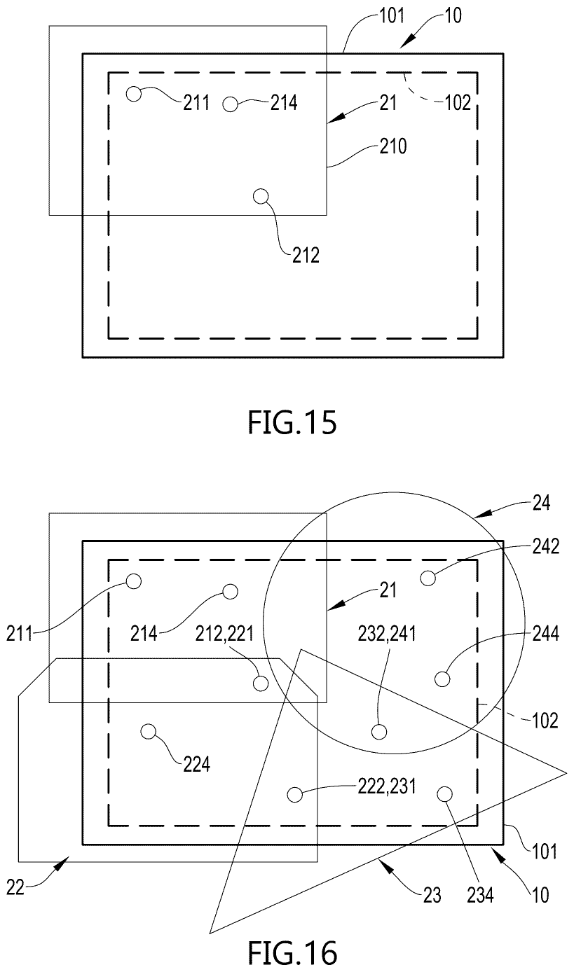

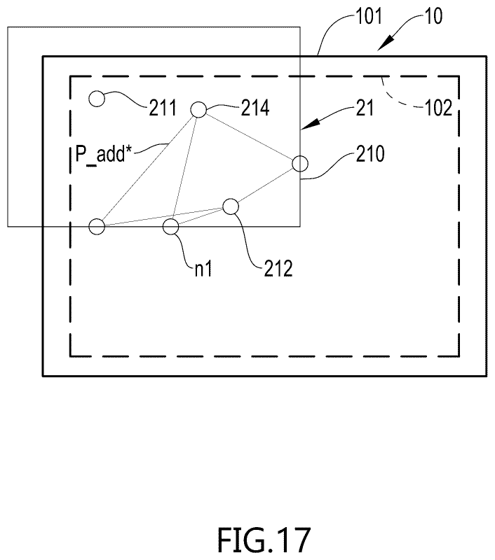

In an embodiment, the processor may set an additional beginning point in each virtual-field map. The position of the additional beginning point is defined by coordinates. So, each virtual-field map has the additional beginning point located. The position of the additional beginning point is within the real movable range. As described in the foregoing embodiment, in the step of setting the first beginning point 211 and the first terminal point 212 of the first virtual-field map 21 by the processor, with reference to FIG. 15, the processor further sets the additional beginning point 214 to the first virtual-field map 21, and the additional beginning point 214 is located within the real movable range 102. That is, the first beginning point 211 as well as the additional beginning point 214 can be the entrances of the first virtual-field map 21. The setting of the additional beginning point 214 can be deduced from the setting of the first beginning point 211 as mentioned above. With reference to FIG. 16, similarly, the second to the fourth virtual-field maps 22-24 may also have the additional beginning points 224,234,244 respectively. Besides, it is understandable that the processor not only generates the multiple first routes P1 along the first beginning point 211, the first nodes n1, and the first terminal point 212 (as shown in FIG. 9), but also generates multiple first additional routes corresponding to the additional beginning points 214. That is, the first additional routes are generated along the additional beginning point 214, the first nodes n1, and the first terminal point 212. Hence, the processor not only determines the N recommending routes P1* from the first routes P1, but also determines one or more than one additional recommending route P_add* as shown in FIG. 17 from the first additional routes by the same manner. So, when the second to the fourth virtual-field maps 22-24 respectively have the additional beginning points 224,234,244, the processor may generate the additional recommending routes corresponding to the additional beginning points 224,234,244. So, the processor will control the monitor to display the recommending routes P1*, P2*, P3*, P4* as well as the additional recommending routes of the first to the fourth virtual-field maps 21-24.

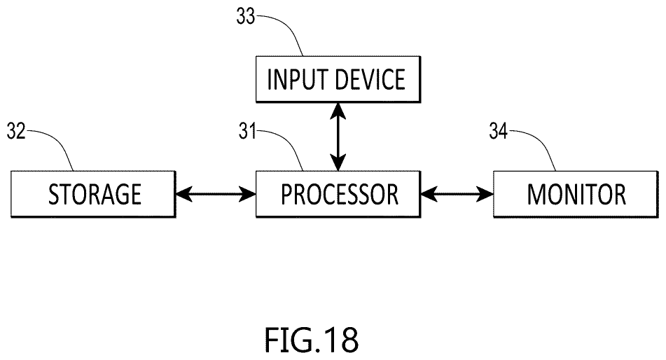

In conclusion, with reference to FIG. 18, a system for recommending moving routes in the virtual field may comprise the above-mentioned processor 31, storage 32, input device 33, and monitor 34. The processor 31 is electrically connected to the storage 32, the input device 33, and the monitor 34. The processor 31 is configured to perform the foregoing moving route recommending method in the virtual field.

What is claimed is:

1. A moving route recommending method in a virtual field performed by a processor and comprising:
receiving a real-field map and multiple virtual-field maps; wherein the real-field map has information of a real movable range, each virtual-field map has information of a virtual map range, and the multiple virtual-field maps include a first virtual-field map and a second virtual-field map;
setting a first beginning point and a first terminal point to the first virtual-field map within the real movable range;
arranging a position of the first virtual-field map to have a maximum overlapping area between the virtual map range of the first virtual-field map and the real movable range;
setting a second beginning point and a second terminal point to the second virtual-field map within the real movable range, wherein a position of the second beginning point corresponds to a position of the first terminal point of the first virtual-field map;
arranging a position of the second virtual-field map to have a maximum overlapping area between the virtual map range of the second virtual-field map and the real movable range;
generating multiple first routes different from each other according to a first-node number, the first beginning point, and the first terminal point in the first virtual-field map, and setting the first N first routes with lengths longer than the rest first routes within the real movable range as N recommending routes of the first virtual-field map; wherein N is a preset number as a positive integer larger than 1, and each first route passes through the first-node number of first nodes;
generating multiple second routes different from each other according to a second-node number, the second beginning point, and the second terminal point in the second virtual-field map, and setting the first M second routes with lengths longer than the rest second routes within the real movable range as M recommending routes of the second virtual-field map; wherein M is a preset number as a positive integer larger than 1, and each second route passes through the second-node number of second nodes; and
controlling a monitor to display the N recommending routes of the first virtual-field map and the M recommending routes of the second virtual-field map.

2. The method as claimed in claim 1, wherein
the virtual map range of each virtual-field map has a virtual movable range;
the step of arranging the position of the first virtual-field map is performed under a condition that the virtual movable range of the first virtual-field map is located within the real movable range to have the maximum overlapping area between the virtual map range of the first virtual-field map and the real movable range; and
the step of arranging the position of the second virtual-field map is performed under a condition that the virtual movable range of the second virtual-field map is located within the real movable range to have the maximum overlapping area between the virtual map range of the second virtual-field map and the real movable range.

3. The method as claimed in claim 1, wherein
the step of arranging the position of the first virtual-field map is to rotate the first virtual-field map around the first beginning point as a fixed point, and compute an overlapping area between the virtual map range of the first virtual-field map and the real movable range during rotation of the first virtual-field map; and
the step of arranging the position of the second virtual-field map is to rotate the second virtual-field map around the second beginning point as a fixed point, and compute an overlapping area between the virtual map range of the second virtual-field map and the real movable range during rotation of the second virtual-field map.

4. The method as claimed in claim 1, wherein
the first-node number is 1, and the second-node number is 1;
the step of generating the multiple first routes is based on an angle defined by a first angle parameter between a line from the first beginning point to the first node of one of the first routes and another line from the first beginning point to the first node of another adjacent first route; and
the step of generating the multiple second routes is based on an angle defined by a second angle parameter between a line from the second beginning point to the second node of one of the second routes and another line from the second beginning point to the second node of another adjacent second route.

5. The method as claimed in claim 1, wherein
each virtual-field map has an additional beginning point located within the real movable range;
the method further comprises: generating an additional recommending route corresponding to the additional beginning point.

6. The method as claimed in claim 1, wherein a position of the first node is preset on a boundary of the virtual map range of the first virtual-field map.

7. The method as claimed in claim 1, wherein
the virtual map range of the first virtual-field map has a virtual movable range;
a position of the first node is preset on a boundary of the virtual movable range of the first virtual-field map.
